(19) United States
(12) Patent Application Publication
(10) Pub. No.: US 2012/0169122 A1
(43) Pub. Date: Jul. 5, 2012

(54) DIRECT CURRENT POWER SWITCH DEVICE

(75) Inventors: Kenji Takahashi, Kanagawa (JP); Toshiaki Takahashi, Kanagawa (JP); Takafumi Oishi, Kanagawa (JP); Hirokazu Otake, Kanagawa (JP); Mitsuhiro Matsuda, Kanagawa (JP); Teruyoshi Goto, Kanagawa (JP); Yuji Takahashi, Kanagawa (JP); Noriyuki Kitamura, Kanagawa (JP); Isao Yamazaki, Kanagawa (JP); Katsusuke Uchino, Kanagawa (JP); Shinichi Kumashiro, Kanagawa (JP)

(73) Assignee: TOSHIBA LIGHTING & TECHNOLOGY CORPORATION, YOKOSUKA-SHI (JP)

(21) Appl. No.: 13/496,706

(22) PCT Filed: Dec. 17, 2010
(86) PCT No.: PCT/JP2010/072764

§ 371 Date: Mar. 16, 2012

(30) Foreign Application Priority Data
Dec. 18, 2009 (JP) 2009-287769
Dec. 8, 2010 (JP) 2010-273451

(51) Int. Cl. H02J 4/00; H01H 9/00

(52) U.S. Cl. 307/39; 307/125

(57) ABSTRACT

Disclosed is a direct current power switch device which safely shuts off direct current power supply without generating arc at the time of shutting off the power supply to an electrical load. The direct current power switch device is provided with: an operation input unit (12), which instructs supply and supply stop of direct current power; a switch contact (14) provided on a power feed line, which supplies the direct current power to a lighting controller (30), i.e., an electrical apparatus that controls power supply; a notifying means, which notifies the lighting controller (30) of power shutoff, in the case where the operation input unit (12) instructed supply stop of the direct current power; and a control unit (11) which opens the switch contact (14) when it is detected that power supply has been controlled to reduce the current in the electrical apparatus after the notification is made.

### TECHNICAL FIELD

An embodiment of the present invention relates to a direct current power switch device such as a wall switch for supplying and stopping a direct current power to an electrical load such as lighting equipment.

### BACKGROUND ART

In various types of electric equipment having an electrical load, in many cases, an alternating current is converted into a direct current and is supplied to an electrical load. If the direct current is supplied from the beginning, a configuration such as an alternating current/direct current converting circuit can be omitted, whereby the conversion loss of the electric power can be reduced to promote a reduction in size and a reduction in cost.

Meanwhile, the electric power obtained by the power generation using natural energy which has attracted attention in recent years starting with a solar power generation is direct current, and it is efficient to supply the electric power to the electrical load as is.

However, in order to perform turn-on control including dimming of the lighting load or the like, a remote switch such as a wall switch is placed between a power source and the lighting load. In the related wiring state, in the case of shifting from the turn-on state of the lighting load to the turn-off, the power source supply to the remote switch is cut off. In this case, when the direct current is supplied, an arc is generated in a switch contact, whereby the switch contact may be damaged.

Although not a countermeasure to an arc generated in the switch contact, a power source receptacle is known which includes an LED displaying an approximation of an amount of electric current (see PTL 1).

With such a configuration, an estimate of the amount of electric current is displayed, and thus a warning is provided, but the problem is not solved in that, when performing the operation of the power source cut-off, an arc is generated, and the switch contact may be damaged.

### CITATION LIST

Patent Literature

[PTL 1] JP-A-2001-196138

### SUMMARY OF INVENTION

### Technical Problem

The invention has been made in view of the present situation of the direct current power switch device as mentioned above, and an object thereof is to provide a direct current power switch device which is able to safely cut off the direct current power source without generating an arc in the case of performing the power source cut-off relative to the electrical load.

### Solution to Problem

According to an embodiment of the invention, there is provided a direct current power switch device which includes an operation input portion for instructing the supply and the supply stop of the direct current power; a switch contact which is provided in a power supply line supplying an electric appliance with direct current power; notification means for performing the notification of the electric power cut-off to the electric appliance when the operation input portion instructs the supply stop of the direct current power; and control means for opening the switch contact when detecting that the power supply control reducing the electric current is performed in the electric appliance after the notification.

### Advantageous Effects of Invention

According to the direct current power switch device relating to the invention, in a case where the operation input portion instructs the supply stop of the direct current power, the notification of the electric power cut-off to the electric appliance is performed, and then, when detecting that the electric power supply control of reducing the electric current to the electrical load is performed in the electric appliance, the switch contact is opened, and thus the opening of the switch contact is performed after the electric current of the power supply line is reduced, whereby it may be expected that direct current power is safely cut off.

### BRIEF DESCRIPTION OF DRAWINGS

FIG. 1 is a configuration diagram that shows a first embodiment of a direct current power switch device according to the invention.

FIG. 2 is a configuration diagram that shows a second embodiment of a direct current power switch device according to the invention.

FIG. 3 is a configuration diagram that shows a third embodiment of a direct current power switch device according to the invention.

FIG. 4 is a configuration diagram that shows a fourth embodiment of a direct current power switch device according to the invention.

FIG. 5 is a configuration diagram that shows a fifth embodiment of a direct current power switch device according to the invention.

FIG. 6 is a configuration diagram that shows a sixth embodiment of a direct current power switch device according to the invention.

### DESCRIPTION OF EMBODIMENTS

The direct current power switch device according to an embodiment of the invention includes an operation input portion for instructing the supply and the supply stop of the direct current power; a switch contact which is provided in a power supply line supplying an electric appliance with the direct current power; notification means for performing the notification of the electric power cut-off to the electric appliance when the operation input portion instructs the supply stop of the direct current power; and control means for opening the switch contact when detecting that the power supply control reducing the electric current is performed in the electric appliance after the notification.

The electric appliance may be connected to an electrical load such as, for example, a lighting load, and may be formed integrally with the electrical load, and includes all appliances which perform the power supply control of on and off of the electric current or the like with respect to a power consumption target. The notification of the notification means may be performed superimposing a signal on the power supply line and may be transmitted by providing a signal line separately from the power supply line. The notification of the notification means includes wireless communication as well as wired. The power supply control reducing the electric current may be reduced until the electric current becomes 0, but the electric current may be reduced to the extent that an arc is not generated between the contracts when opening the switch contact.

In the direct current power switch device according to the embodiment of the invention, the control means opens the switch contact when detecting a state where the power control is performed which reduces the electric current to a current value in which an arc is not generated in the switch contact.

In the direct current power switch device according to the embodiment of the invention, the switch contact includes a plurality of switch contacts connected to a plurality of electrical appliances, when the operation input portion instructs the supply stop of the direct current power to a desired electric appliance, the notification means performs the notification of the power cut-off to the corresponding electric appliance, and when the control means detects that the power supply control reducing the electric current is performed in the electric appliance after the notification, the control means opens the corresponding switch contact.

The direct current switch device according to the embodiment of the invention includes receiving means for receiving the notification of the power supply control from the electric-appliance, and the control means opens the switch contact when receiving the notification of the power supply control in the receiving means.

The direct current power switch device according to the embodiment of the invention includes a timer that counts the time from when performing the notification of the power cut-off to the electric appliance, and the control means opens the switch contact when detecting the passage of a predetermined time by the timer.

The direct current power switch device according to the embodiment of the invention includes detection means for detecting the electric current flowing through a power supply line, and the control means opens the switch contact when detecting that the detected amount of electric current is equal to or less than a predetermined value by the detection means.

The direct current power switch device according to the invention includes receiving means for receiving a response to the notification from the electric appliance, and detection means for detecting the electric current flowing through the power supply line, and the control means opens the switch contact when receiving the notification of the power control in the receiving means and detecting that the detected amount of current is equal to or less than a predetermined value in the detection means.

The direct current power switch device according to the embodiment of the invention performs the notification of the power supply to the electric appliance after closing the switch contact, when the operation input portion instructs the supply of the direct current power.

Hereinafter, an embodiment of the direct current power switch device according to the invention will be described with reference to the attached drawings. In the respective drawings, the same components will be denoted by the same reference numerals and the repeated description will be omitted.

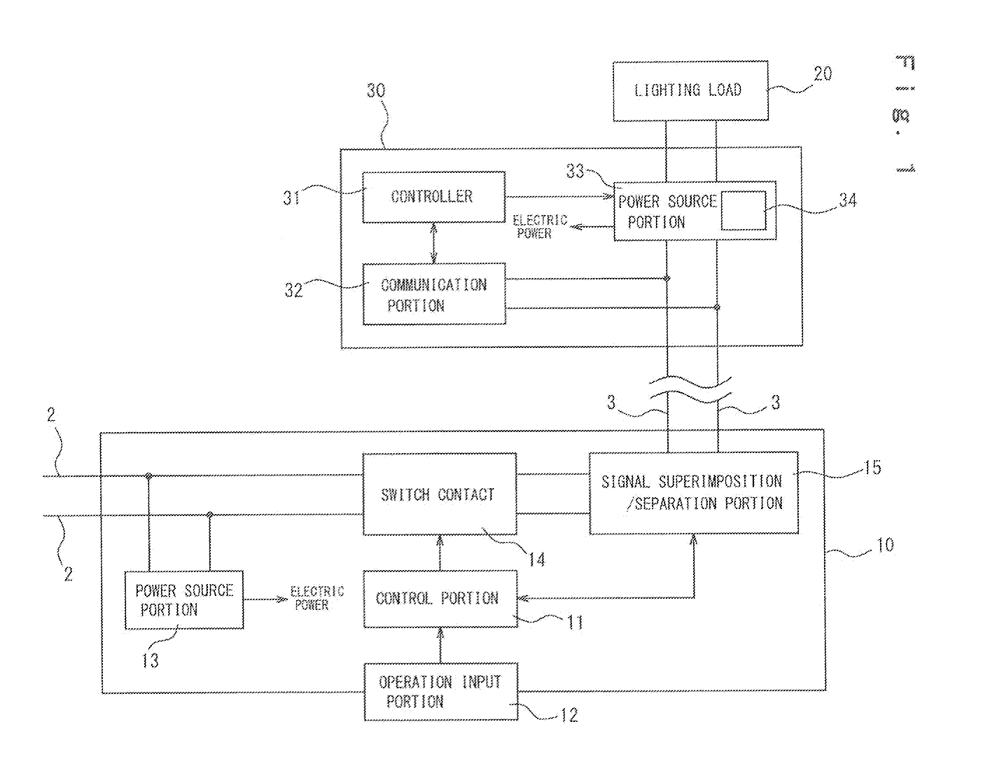

FIG. 1 shows a configuration diagram of a lighting system which includes a wall switch 10 as a direct current power switch device according to a first embodiment, and a lighting controller 30 that is an electric appliance performing the power supply control on a lighting load 20.

The direct current power is sent from a direct current power source to the wall switch 10 via power source side power supply lines 2 and 2. The wall switch 10 includes a control portion 11, an operation input portion 12, a power source portion 13, a switch contact 14, and a signal superimposition/separation portion 15.

The power source portion 13 receives the electric power via the power source side power supply lines 2 and 2, and supplies the respective portions including the control portion 11 with the electric power, for example, by converting the electric power to a predetermined voltage. The direct current power source supplied from the power source side power supply lines 2 and 2 reaches load side power supply lines 3 and 3 via the switch contact 14 and the signal superimposition/separation portion 15, and is transmitted to the lighting controller 30.

The operation input portion 12 is to instruct the supply and the supply stop of the direct current power, and includes a manual operation portion such as a tact switch. By operating the operation portion, the operation input portion 12 instructs the supply and the supply stop of the direct current power to the control portion 11.

The control portion 11 causes the signal superimposition/separation portion 15 to notify the power cut-off to the lighting controller 30 in the case of receiving the instruction of the supply stop of the direct current power by the operation input portion 12. The signal superimposition/separation portion 15 is notification means which has transmission and reception functions and superimposes the signal on the load side power supply lines 3 and 3 to notify the power cut-off to the lighting controller 30.

The lighting controller 30 includes a controller 31, a communication portion 32, and a power source portion 33. The communication portion 32 has the same function as that of the signal superimposition/separation portion 15, and transmits and receives the signal between itself and the signal superimposition/separation portion 15 via the load side power supply lines 3 and 3. The communication portion 32 takes information from the received signal, sends the information to the controller 31, superimposes information received from the controller 31 on the load side power supply lines 3 and 3 as a signal, and transmits the signal to the signal superimposition/separation portion 15.

The power source portion 33 converts the voltage of the direct current obtained from the load side supply lines 3 and 3 as necessary, provides it to the controller 31 and the communication portion 32, and also supplies it to the lighting load 20. The electric current supplied from the power source portion 33 to the controller 31 and the communication portion 32 is a slight current value. Furthermore, the power source portion 33 includes a circuit creating the power applied to the lighting load 20 or a circuit performing the power supply, and the circuit is provided with a power supply adjusting portion 34 constituted by a semiconductor switch and a variable resistance.

The controller 31 controls the power supply adjusting portion 34 of the power source portion 33 when receiving the notification of the power cut-off from the wall switch 10, and performs the power control which reduces the electric current to the electric current value in which an arc is not generated in the switch contact 14. For example, through the power supply control, the electric current flowing through the load side power supply lines 3 and 3 is small or zero to the extent that an arc is not generated in the switch contact 14. The controller 31 performing the power supply control controls the communication portion 32, and sends the notification of the power supply control from the load side power supply lines 3 and 3 to the wall switch 10.

The notification of the power supply control is received by the control portion 11 via the signal superimposition/separation portion 15 in the wall switch 10. The control portion 11 receives the notification of the power supply control to open the switch contact 14. At this time, in the lighting controller 30, through the power supply adjusting portion 34, the amount of current is small or zero to the extent that arc is not generated in the switch contact 14. That is, even if the power source portion 33 supplies the controller 31 and the communication portion 32 with the electric power, the electric current flowing through the load side power supply lines 3 and 3 is very small, and the power cut-off can be safely performed regardless of the opening of the switch contact 14 without generating an arc.

Next, a case of supplying the electric power to the lighting controller 30 will be described. Firstly, when operating the operation input portion 12 which supplies the lighting controller 30 with the electric power, the operation input portion 12 instructs the supply of the direct current power to the control portion 11. Moreover, the control portion 11 performs the notification of the power supply from the signal superimposition/separation portion to the lighting controller 30 after closing the switch contact 14. Herein, at the point of time when closing the switch contact 14, the power source portion 33 of the lighting controller 30 is supplied with the electric power and the power source portion 33 supplies the controller 31 and the communication portion 32 with the electric power, and thus, the lighting controller 30 enters a state where the notification of the power supply from the wall switch can be received. In addition, even when closing the switch contact 14, the amount of current flowing through the load side Power supply lines 3 and 3 is zero or small current in which an arc is not generated in the switch contact 14, and thus, an arc is not generated in the switch contact 14.

The notification of the power supply transmitted from the wall switch 10 is performed such that information is retrieved by the communication portion 32 and is sent to the power source portion 33 via the controller 31. Moreover, the power supply to the lighting load 20 is controlled by the power supply adjusting portion 34 of the power source portion 33.

According to the direct current power switch device relating to the present embodiment, since the notification of the power supply to the lighting controller 30 as the electric appliance after closing the witch contact 14 is performed, it is possible to start the supply of the direct current power in the state where an arc is not generated in the switch contact 14.

As mentioned above, when the amount of current flowing through the load side power supply lines 3 and 3 is zero or small in which an arc is not generated in the switch contact 14, the switch contact 14 can be closed. Thus, it is possible to supply the direct current power to the lighting controller 30 in the state where an arc is not generated in the switch contact.

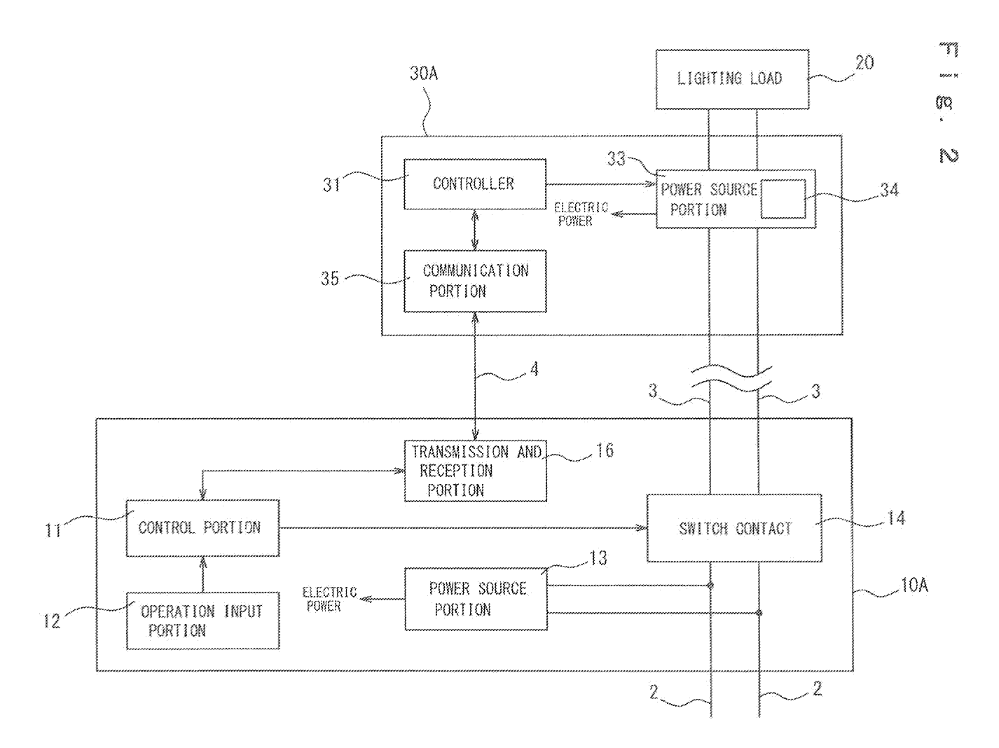

FIG. 2 shows a configuration diagram of a wall switch 10A and a lighting controller 30A according to a second embodiment. In the present embodiment, the signal is not superimposed on the load side power supply lines 3 and 3, a transmission and reception portion 16 and a communication portion 35 perform the transmission and the reception of the signal via a wire or wireless line 4, and sends and receives the notification of the power cut-off and the notification of the power supply control. Other configurations are the same as those of the first embodiment.

In the present embodiment, when the instruction of the supply and the supply stop of the direct current power is given to the control portion 11 by the operation of the operation input portion 12, the control portion 11 controls the transmission and reception portion 16 to send the notification of the power cut-off to the lighting controller 30A. In response to this, the controller 31 receives the notification of the power cut-off from the wall switch 10 via the communication portion 35, controls the power supply adjusting portion 34 of the power source portion 33, and performs the power supply control which sets the amount of current to a small value or zero to the extent that an arc is not generated in the switch contact 14.

The controller 31 performing the power supply control controls the communication portion 35 to send the notification of the power supply control to the wall switch 10A via the line 4. The notification of the power supply control is received by the control portion 11 via the transmission and reception portion 16 in the wall switch 10A. The control portion 11 receives the notification of the power supply control and opens the switch contact 14.

According to the direct current power switch device relating to the present embodiment, since the switch contact 14 is opened in the case of receiving the notification of the power supply control from the lighting controller 30A as the electric appliance, it is possible to perform the opening of the switch contact 14 in the state where the electric current of the load side power supply lines 3 and 3 is reduced.

With this configuration, it is also possible to safely perform the power cut-off regardless of the opening of the switch contact 14 without generating an arc.

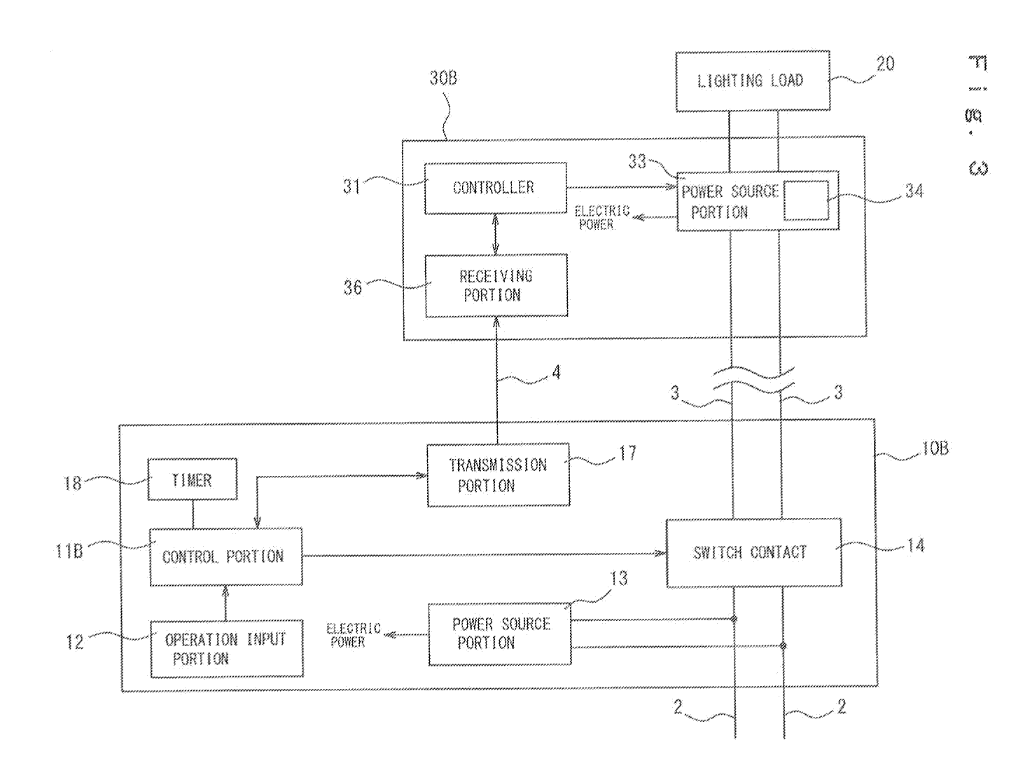

FIG. 3 shows a configuration diagram of a wall switch 10B and a lighting controller 30B according to a third embodiment. In the present embodiment, the wall switch 10B is equipped with a transmission portion 17 performing the transmission of the signal, and the lighting controller 30B is equipped with a reception portion 36 performing the reception of the signal. The control portion 11B only controls the transmission portion 17 to transmit the notification of the power cut-off to the lighting controller 30B, but does not receive the return.

A timer 18 is connected to the control portion 11B (the timer 18 may be equipped in the Control portion 11B), and the control portion 11B starts the timer 18 when controlling the transmission portion 17 to transmit the notification of the power cut-off of the lighting controller 30A. After that, the control portion 116 monitors the timer 18, and opens the switch contact 14 when a predetermined time elapses. The predetermined time is a time in which a margin time is added to a time required until the controller 31 receives the notification of the power cut-off from the wall switch 10, controls the power supply adjusting portion 34 of the power source portion 33, and sets the amount of current to the small value or zero to the extent that an arc is not generated in the switch contact 14.

According to the configuration, when the instructions of the supply and the supply stop of the direct current power are given to the control portion 11B by the operation through the operation input portion 12, the control portion 11B controls the transmission portion 17 to transmit the notification of the power cut-off to the lighting controller 30B. In response to this, the controller 31 receives the notification of the power cut-off from the wall switch 10B via the reception portion 36, controls the power supply adjusting portion 34 of the power source portion 33, and executes the power supply control which sets the amount of current to a small value or zero to the extent that an arc is not generated in the switch contact 14.

Next, as mentioned above, the control portion 11B starts the timer 18, monitors the timer 18, detects the state of performing the power control of reducing the electric current to the current value in which an arc is not generated in the switch contact 14 when detecting the passage of a predetermined time, and opens the switch contact 14.

According to the direct current switch device relating to the present embodiment, in the case of detecting the passage of the predetermined time from the time when performing the notification of the power cut-off to the lighting controller 30B as the electric appliance, the switch contact 14 is opened. Thus, after performing the power cut-off by the lighting controller 30B, the switch contact 14 can be opened in the state where the electric current of the load side power lines 3 and 3 is reduced to the current value in which an arc is not generated in the switch contact 14. With such a configuration, it is also possible to safely perform the power cut-off regardless of the opening of the switch contact 14 without generating the arc.

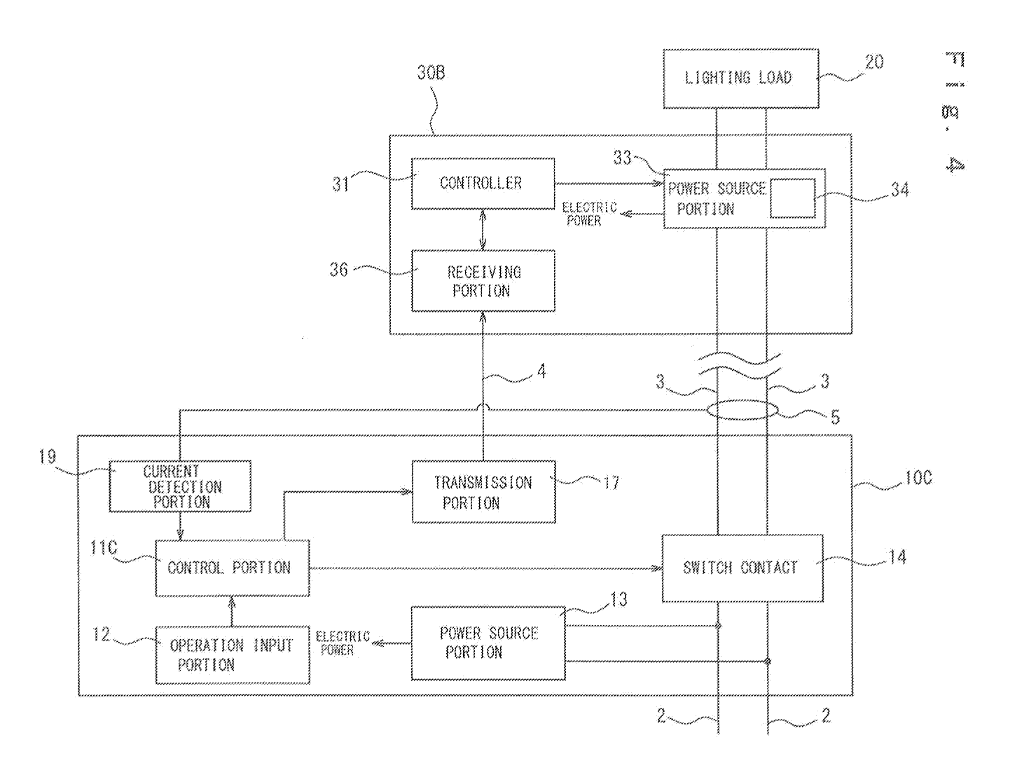

FIG. 4 shows a configuration diagram of a wall switch 10C and a lighting controller 30B according to a fourth embodiment. In the embodiment, the wall switch 10C is equipped with a current detection portion 19 in place of the timer 18 used in the third embodiment. The load side power supply lines 3 and 3 are provided with a current sensor 5 such as a current transformer, and the current detection portion 19 detects the amount of current based on the output thereof.

The control portion 11C takes the amount of current detected by the current detection portion 19. The control portion 11C opens the switch contact 14 when detecting that the amount of current taken is equal to or less than a predetermined value.

According to the configuration, when the instructions of the supply and the supply stop of the direct current power are given to the control portion 11C by the operation through the operation input portion 12, the power cut-off is notified to the lighting controller 30B. In response to this, the controller 31 controls the power supply adjusting portion 34 of the power source portion 33, and executes the power supply control which sets the amount of current to the small value or zero to the extent that an arc is not generated in the switch contact 14. The operations mentioned above are the same as those of the third embodiment.

Next, the control portion 11C monitors the amount of current detected by the current detection portion 19, and opens the switch contact 14 when detecting that the detected amount of current is equal to or less than a predetermined value to the extent that an arc is not generated in the switch contact 14.

According to the direct current power switch device according to the present embodiment, when the electric current flowing through the load side power supply lines 3 and 3 is detected and it is detected that the detected amount of current is equal to or less than the predetermined value, the switch contact 14 is opened. Thus, it is possible to safely cut off the direct current power in the state where an arc is not generated in the switch contact 14.

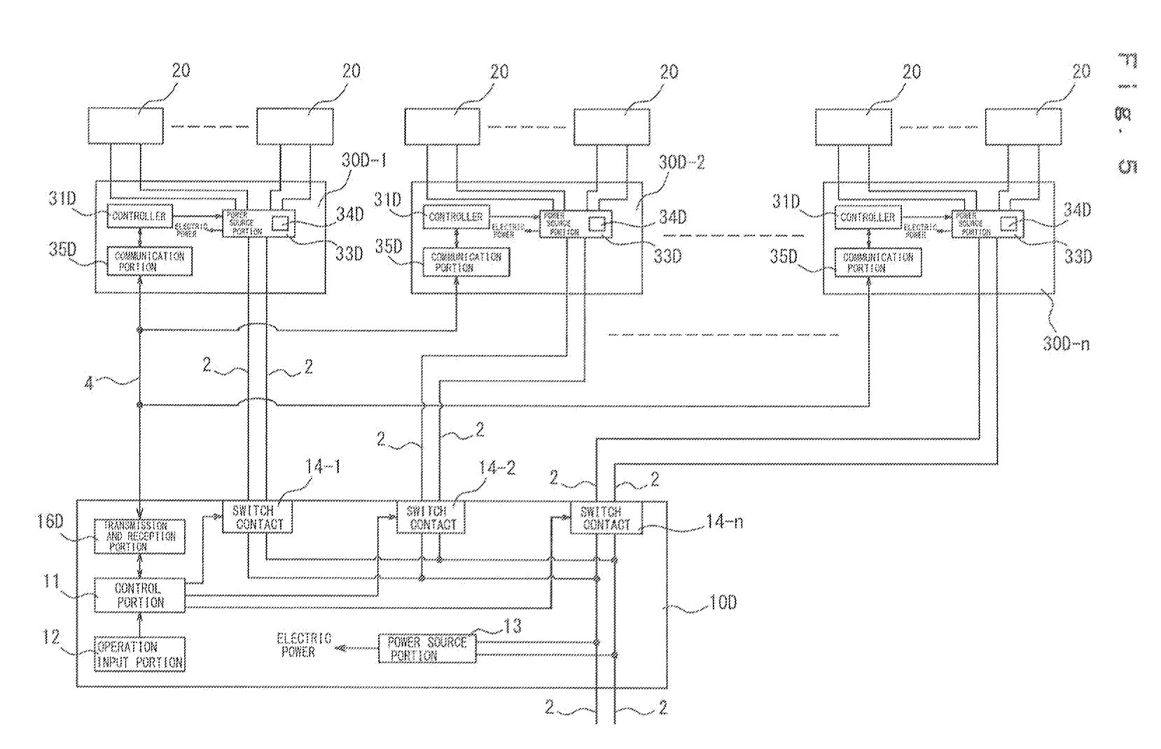

FIG. 5 shows a configuration diagram of the lighting system constituted by a wall switch 10D and a lighting controller 30D according to a fifth embodiment. In the present embodiment, a plurality of lighting controllers 30D-1 to 30D-n (n is an integer equal to or greater than 2) is provided. The lighting controllers 30D-1 to 30D-n are connected to a plurality of lighting loads 20, . . . , 20, respectively.

The lighting controllers 30D-1 to 30D-n include a controller 31D, a power source portion 33D, and a communication portion 35D, respectively. The power source portion 33D converts the voltage of the direct current power taken from the load side power supply lines 3 and 3 as necessary, provides the same to the controller 310 and the communication portion 32D, and also supplies the same to the plurality of lighting loads 20, . . . , 20. The power source portion 33D is equipped with a circuit which creates the electric power given to the lighting load 20 or a circuit which performs the power supply, and the circuit is provided with a power supply adjusting portion 34D constituted by a semiconductor switch and a variable resistance. The power supply adjusting portion 34D is controlled by the controller 31D, and performs the power control which reduces , the electric current to the current value in which an arc is not generated in the switch contact 14 (14-1 to 14-n).

The wall switch 10D includes switch contacts 14-1 to 14-n which are connected to the lighting controllers 30D-1 to 30D-n via the power source side supply lines 2 and 2. The operation input portion 120 has an operation portion which is able to input the instruction of the power control relative to the lighting loads 20 of the respective lighting controllers 30D-1 to 30D-n. When operating the operation portion, the operation input portion 12D instructs the supply and the supply stop of the direct current power of the corresponding lighting controller 30D of the respective lighting controllers 30D-1 to 30D-n to the control portion 11D. When the operation input portion 120 instructs the supply stop of the direct current power of the desired lighting controller 30D, the control portion 110 causes the transmission and reception portion 16D to perform the notification of the power cut-off to-the lighting, controller 30D.

The transmission and reception portion 16D is able to communicate with communication portions 35D of the lighting controllers 30D-1 to 30D-n, and performs the identification of the lighting controllers 30D-1 to 30D-n by including the address in communication information. The configuration of the present embodiment is the same as that of the second embodiment except for the configuration as mentioned above.

According to the configuration, it is possible to individually perform the supply and the supply stop of the direct current power in the lighting controllers 30D-1 to 30D-n. In addition, it is possible to expect that the power cut-off is safely performed regardless of the opening of the switch contacts 14-1 to 14-n without generating the arc. Like the present embodiment, it is possible to adopt a configuration, in which the plurality of lighting controllers 30D-1 to 30D-n and the plurality of lighting loads 20, . . . , 20 that are provided in the plurality of lighting controllers 30D-1 to 30D-n, respectively are provided, and the supply and the supply stop of the direct current power are individually performed with respect to the lighting controllers 30D-1 to 30D-n, in any one of the first embodiment to the fourth embodiment, and the sixth embodiment.

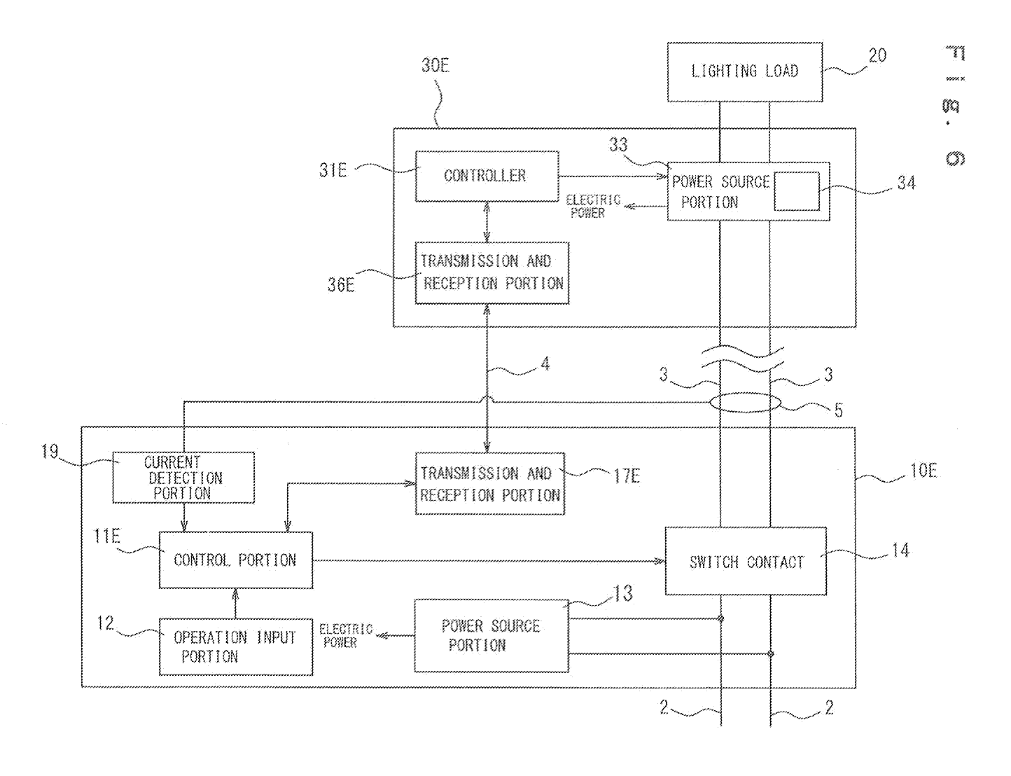

FIG. 6 shows a configuration diagram of a lighting system constituted by a wall switch 10E and a lighting controller 30E according to a sixth embodiment. In the present embodiment, a transmission and reception portion 17E of the wall switch 10E and a transmission and reception portion 36E of the lighting controller 30E perform a two-way communication via a wired or wireless line 4. When the instructions of the supply and the supply stop of the direct current power are given to the control portion 11E by the operation through the operation input portion 12, the power cut-off is notified from the transmission and reception portion 17E to the transmission and reception portion 36E of the lighting controller 30E.

The controller 31E, which receives the notification mentioned above from the transmission and reception portion 36E, controls the power supply adjusting portion 34 of the power source portion 33, executes the power supply control which reduces the electric current to the current value in which an arc is not generated in the switch contact 14, and sends a response (ACK) of the power supply control from the transmission and reception portion 36E to the transmission and reception portion 17E.

The control portion 11E receives the response (ACK) of the power supply control from the transmission and reception portion 17E, monitors the amount of current detected by the current detection portion 19, and opens the switch contact 14 when detecting that the detected amount of current is equal to or less than a predetermined value. Configurations other than those mentioned above are the same as those of the fourth embodiment. With the fifth embodiment, it is possible to safely perform the power cut-off regardless of the opening of the switch contact 14 without generating the arc.

According to the sixth embodiment, by a double-check in which it is detected that the response (ACK) of the power supply control is returned and the amount of current detected by the current detection portion 19 is equal to or less than a predetermined value, the opening of the switch contact 14 is performed. For this reason, the opening of the switch contact 14 is performed by the double-check, whereby it is certain that an arc is not generated regardless of the opening of the switch contact 14, the power cut-off can be safely performed, and the safety of the system is improved.

In addition, in the second to sixth embodiments mentioned above, in the case of supplying the electric power to the lighting controllers 30A to 30E, like the first embodiment, the power supply is notified to the lighting controllers 30A to 30E after closing the switch contact 14. Furthermore, in any embodiment, when the controller 31 is started immediately after the switch contact 14 is closed, it is possible to set the electric current flowing through the load side supply lines 3 and 3 to a low current state. After that, it is possible to perform the control which raises the output so that the power supply to the lighting load 20 is allowed after a predetermined time elapses. As a result, it is possible to prevent a large electric current from flowing in an unstable state immediately after closing the switch contact 14, whereby a safe power supply can be expected.

Furthermore, in a case where the switch contact 14 is opened, as a standby state in which the lighting controllers 30A to 30E consume the standby power required for receiving the signal from the wall switches 10A to 10E, next, it is possible to perform the power control which reduces the electric current to the current value in which an arc is not generated in the switch contact 14.

Furthermore, the embodiments mentioned above can be suitably combined with each other, and it is possible to perform various modifications depending on the spirit of the invention, for example, by superimposing and performing the notification of the power supply or the power cut-off on the load side supply lines 3 and 3 in the third or fourth embodiment.

### REFERENCE SIGNS LIST

2 power source side supply line
3 load side supply line
5 current sensor
10, 10A to 10E wall switch
11, 11B, and 11C control portion
12 operation input portion
13 power source portion
14 switch contact
18 timer
19 current detection portion
20 lighting load
30, 30A to 30E lighting controller
31 controller
33 power source portion
34 power supply adjusting portion

1. A direct current power switch device comprising:
an operation input portion for instructing a supply and a supply stop of a direct current power;
a switch contact which is provided in a power supply line supplying an electric appliance with the direct current power;
notification means for performing the notification of the electric power cut-off to the electric appliance when the operation input portion instructs the supply stop of the direct current power; and
control means for opening the switch contact when detecting that the power supply control reducing the electric current is performed in the electric appliance after the notification.

2. The direct current power switch device according to claim 1,
wherein the control means opens the switch contact when detecting a state where the power control is performed which reduces the electric current to a current value in which an arc is not generated in the switch contact.

3. The direct current power switch device according to claim 1,
wherein the switch contact includes a plurality of switch contacts connected to a plurality of electric appliances,
when the operation input portion instructs the supply stop of the direct current power to a desired electric appliance, the notification means performs the notification of the power cut-off to the corresponding electric appliance, and
the control means opens the corresponding switch contact when detecting that the power supply control reducing the electric current is performed in the electric appliance after the notification.

4. The direct current power switch device according to claim 1, further comprising:
receiving means for receiving the notification of the power supply control from the electric appliance,
wherein the control means opens the switch contact when receiving the notification of the power supply control in the receiving means.

5. The direct current power switch device according to claim 1, further comprising:
a timer that counts the time from when performing the notification of the power cut-off to the electric appliance,
wherein the control means opens the switch contact when detecting the passage of a predetermined time by the timer.

6. The direct current power switch device according to claim 1, further comprising:
detection means for detecting the electric current flowing through a power supply line,
wherein the control means opens the switch contact when detecting that the detected amount of electric current is equal to or less than a predetermined value by the detection means.

7. The direct current power switch device according to claim 1, further comprising:
receiving means for receiving a response to the notification from the electric appliance; and
detection means for detecting the electric current flowing through the power supply line,
wherein the control means opens the switch contact when receiving the notification of the power control in the receiving means and detecting that the detected amount of current is equal to or less than a predetermined value in the detection means.

8. The direct current power switch device according to claim 1,
wherein the notification of the power supply to the electric appliance is performed after closing the switch contact, when the operation input portion instructs the supply of the direct current power.

9. The direct current power switch device according to claim 2,
wherein the switch contact includes a plurality of switch contacts connected to a plurality of electric appliances,
when the operation input portion instructs the supply stop of the direct current power to a desired electric appliance, the notification means performs the notification of the power cut-off to the corresponding electric appliance, and
the control means opens the corresponding switch contact when detecting that the power supply control reducing the electric current is performed in the electric appliance after the notification.

10. The direct current power switch device according to claim 2, further comprising:
receiving means for receiving the notification of the power supply control from the electric appliance,
wherein the control means opens the switch contact when receiving the notification of the power supply control in the receiving means.

11. The direct current power switch device according to claim 2, further comprising:
a timer that counts the time from when performing the notification of the power cut-off to the electric appliance,
wherein the control means opens the switch contact when detecting the passage of a predetermined time by the timer.

12. The direct current power switch device according to claim 2, further comprising:
detection means for detecting the electric current flowing through a power supply line,
wherein the control means opens the switch contact when detecting that the detected amount of electric current is equal to or less than a predetermined value by the detection means.

13. The direct current power switch device according to claim 2, further comprising:
receiving means for receiving a response to the notification from the electric appliance; and
detection means for detecting the electric current flowing through the power supply line,
wherein the control means opens the switch contact when receiving the notification of the power control in the receiving means and detecting that the detected amount of current is equal to or less than a predetermined value in the detection means.

14. The direct current power switch device according to claim 2,
wherein the notification of the power supply to the electric appliance is performed after closing the switch contact, when the operation input portion instructs the supply of the direct current power.

15. The direct current power switch device according to claim 3,
wherein the notification of the power supply to the electric appliance is performed after closing the switch contact, when the operation input portion instructs the supply of the direct current power.

16. The direct current power switch device according to claim 4,
wherein the notification of the power supply to the electric appliance is performed after closing the switch contact, when the operation input portion instructs the supply of the direct current power.

17. The direct current power switch device according to claim 5,
wherein the notification of the power supply to the electric appliance is performed after closing the switch contact, when the operation input portion instructs the supply of the direct current power.

18. The direct current power switch device according to claim 6,
wherein the notification of the power supply to the electric appliance is performed after closing the switch contact, when the operation input portion instructs the supply of the direct current power.

19. The direct current power switch device according to claim 7,
wherein the notification of the power supply to the electric appliance is performed after closing the switch contact, when the operation input portion instructs the supply of the direct current power.
